(19) United States
(12) Patent Application Publication
(10) Pub. No.: US 2023/0092737 A1
(43) Pub. Date: Mar. 23, 2023

(54) ABUSE TOLERANT ELECTROLYTE FOR LITHIUM-ION BATTERY CELLS

(71) Applicant: Apple Inc., Cupertino, CA (US)

(72) Inventors: Vinay Bhat, Cupertino, CA (US); Cory R. O'Neill, Cupertino, CA (US); William A. Braff, Cupertino, CA (US); Rachel Ann R. Villamayor Huang, Cupertino, CA (US)

(21) Appl. No.: 17/865,991

(22) Filed: Jul. 15, 2022

Related U.S. Application Data
(60) Provisional application No. 63/246,214, filed on Sep. 20, 2021.
(60) Provisional application No. 63/246,216, filed on Sep. 20, 2021.
(60) Provisional application No. 63/350,538, filed on Jun. 9, 2022.

(51) Int. Cl. H01M 10/0567; H01M 10/0525; H01M 10/0569; H01M 4/525; H01M 4/505; H01M 4/58

(52) U.S. Cl. CPC H01M 10/0567; H01M 10/0525; H01M 10/0569; H01M 4/525; H01M 4/505; H01M 4/5825; H01M 2300/0042

(57) ABSTRACT

This disclosure relates to battery cells, and more particularly, electrolyte formulations that reduce thermal runaway in lithium ion battery cells.

### CROSS-REFERENCE TO RELATED PATENT APPLICATION

This patent application claims the benefit under 35 U.S.C. § 119(e) of U.S. Patent Application No. 63/246,214, entitled “Abuse Tolerant Electrolyte for Lithium-Ion Battery Cells”, filed on Sep. 20, 2021, U.S. Patent Application No. 63/246,216, entitled “Abuse Tolerant Electrolyte for Lithium-Ion Battery Cells”, filed on Sep. 20, 2021, and U.S. Patent Application No. 63/350,538, entitled “Abuse Tolerant Electrolyte for Lithium-Ion Battery Cells”, filed on Jun. 9, 2022, each of which are incorporated herein by reference in its entirety.

### FIELD

This disclosure relates generally to battery cells, and more particularly, electrolyte additives for use in lithium ion battery cells.

### BACKGROUND

Lithium ion (Li-ion) batteries are widely used as the power sources in consumer electronics. Consumer electronics need Li-ion batteries which can deliver higher volumetric energy densities and sustain more discharge-charge cycles. A Li-ion battery typically works at a voltage up to 4.45 V (full cell voltage).

A battery pack can include multiple battery cells. Under abnormal conditions, battery cells can experience a thermal event, referred to as thermal runaway. Thermal runaway of a battery cell refers to a condition in which the battery cell produces heat faster than it can be dissipated, resulting in an increase in temperature that increases the rate of heat generation.

### SUMMARY

In a first aspect, the disclosure is directed to a battery cell including a cathode and an anode, with a separator disposed therebetween. The cathode includes a cathode active material disposed on a cathode current collector. The anode includes an anode active material disposed on an anode current collector. The cathode active material and anode active material are oriented toward and face each other. An electrolyte formulation that includes 0.01 wt %-30.0 wt % ethylene carbonate (EC) relative to the total weight of the electrolyte formulation, and an SEI-forming lithium salt, is disposed between the cathode and anode. The battery further includes a SEI-forming lithium salt—solid electrolyte interface (SEI) on the surface of the anode active material. In some variations, an EC SEI is formed on the lithium salt SEI.

In a second aspect, the SEI-forming lithium salt is selected from lithium difluoro(oxalato)borate (LiDFOB), lithium bis(oxalate) borate (LiBOB), lithium tetrafluoro oxalato phosphate (LiTFOP), lithium difluoro bis(oxalato) phosphate (LiDFBOP) and lithium difluorophosphate (LiDFP). In some variations, the SEI-forming lithium salt is lithium difluoro(oxalato)borate (LiDFOB).

In a third aspect, the disclosure is directed to a method of making a battery cell. The method includes obtaining the uncharged battery cell including the cathode, the anode, and the separator. An electrolyte formulation including equal to or less than 30 wt % ethylene EC of the total weight of the electrolyte formulation and SEI-forming lithium salt is disposed between the cathode and anode. A first voltage equal to or greater than 1.8 V and less than 2.4 V is applied to the battery cell to form an SEI-forming lithium salt SEI. In additional variations, s second voltage equal to or greater than 2.5V is applied to the battery cell to form an EC SEI on the SEI-forming lithium salt SEI.

In a fourth aspect, the electrolyte formulation includes an electrolyte salt, such as LiPF₆, LiN(SO₂F)₂, LiBF₄, LiClO₄, LiSO₃CF₃, LiN(SO₂CF₃)₂, LiBC₄O₈, LiBF₂(C₂O₄), Li[PF₃(C₂CF₅)₃], LiC(SO₂CF₃)₃, and a combination thereof. In a specific variation, the electrolyte salt is LiPF₆. In various aspects, the electrolyte salt can have a concentration of 0.6 M to 1.6 M of the electrolyte formulation.

In fifth aspect, one or more additional solvents selected from propylene carbonate (PC), dimethyl carbonate (DMC), diethyl carbonate (DEC), ethyl propionate (EP), butyl butyrate (BB), methyl acetate (MA), ethyl acetate (EA), propyl propionate (PP), butyl propionate (BP), propyl acetate (PA), and butyl acetate (BA), and a combination thereof.

In a sixth aspect, the electrolyte formulation can include one or more additional additives. The additional additives can be selected from vinylene carbonate (VC), propylene sultone (PS), fluoroethylene carbonate (FEC), succinonitrile (SN), 1,3,6-hexanetricarbonitrile (HTCN), tris(trimethylsilyl) phosphite (TMSP), and a combination thereof.

In a seventh aspect, the battery cell can be selected from a lithium containing layered oxide having the formula LiₓMO₂, a spinel having the formula LiₓM₂O₂, and an olivine having the formula LixMPO₄, wherein M is one or more transition metals and 0.90≤x≤1.10. In some variations, the cathode active material is LiMPO₄, such as LiFePO₄ and LiMn_{0.8}Fe_{0.2}PO₄ (LMFP).

In an eighth aspect, anodes can be formed of carbon, such as graphite.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment; and

FIG. 2 is a perspective view of a battery cell, in accordance with an illustrative embodiment;

FIG. 3 depicts a differential scanning calorimetry plot of normalized heat capacity as a function of temperature for a charged battery cell containing the electrolyte formulation 1M LiPF₆, EC:EMC::30:70, and 2 wt % vinyl carbonate (VC), in accordance with illustrative embodiments;

FIG. 4 depicts a bar graph of the average normalized heat capacity for three electrolyte formulations containing 1M LiPF₆, 2 wt % vinyl carbonate (VC), and one of 30 wt %, 15 wt %, or 0 wt % EC with the remainder replaced by EMC, in accordance with illustrative embodiments;

FIG. 5A depicts the dQ/dV as a function of cell voltage for the formation of SEI on the graphite anode for different electrolyte formulations, in accordance with illustrative embodiments;

FIG. 5B depicts a representation of SEIs formed from LiDFOB and EC, in accordance with an illustrative embodiment;

FIG. 6A depicts the dQ/dV as a function of cell voltage for battery cells having electrolyte formulation containing LiDFOB and different quantities of EC, in accordance with illustrative embodiments;

FIG. 6B depicts a DSC for the battery cells having electrolyte formulation containing LiDFOB and different quantities of EC, in accordance with illustrative embodiments;

FIG. 7 depicts the heating rate of battery cells with electrolyte formulations containing LiDFOB and different quantities of EC, in accordance with illustrative embodiments;

FIG. 8A depicts the discharge capacity as a function of cycle number for battery cells containing three separate electrolyte formulations, in accordance with illustrative embodiments;

FIG. 8B depicts a bar graph for gas creation of battery cells having three different electrolyte formulations, in accordance with illustrative embodiments;

FIG. 9A depicts the discharge energy rate performance as a function of discharge rate for three different electrolyte formulations, in accordance with illustrative embodiments;

FIG. 9B depicts the charge capacity rate performance as a function of discharge rate for three different electrolyte formulations, in accordance with illustrative embodiments;

FIG. 10 depicts the dQ/dV as a function of cell voltage for the formation of SEI on the graphite anode for different electrolyte formulations, in accordance with illustrative embodiments;

FIG. 11 depicts differential scanning calorimeter (DSC) tests showing that electrolytes containing the SEI-forming lithium salts LiDFOB, LiDFBOP, LiBOB, LiTFOP and LiDFP, in accordance with illustrative embodiments;

FIG. 12A depicts an accelerated rate calorimetry (ARC) testing of the LFP/graphite pouch cells with the test electrolytes containing the SEI-forming lithium salts LiDFOB, LiDFBOP, LiBOB, LiTFOP, and LiDFP each reduce the heating rate and the cell temperature during thermal runaway, in accordance with illustrative embodiments;

FIG. 12B depicts the maximum cell heating rate for different SEI-forming lithium salts having O—B and O—P chemical structures as compared to a control, in accordance with illustrative embodiments; and

FIG. 13 depicts the cycle aging of LFP/graphite pouch cells with electrolytes containing the SEI-forming lithium salts as compared to a control at 50° C., in accordance with illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

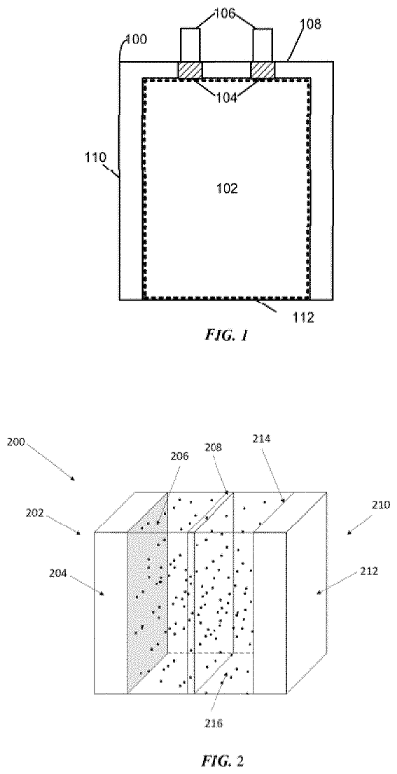

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode (e.g., aluminum foil coated with a lithium compound) and one strip of anode (e.g., copper foil coated with graphite). The stack 102 also includes one strip of separator material (e.g., a microporous polymer membrane or non-woven fabric mat) disposed between the cathode and anode. The cathode, anode, and separator may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Electrolyte formulation 216 is disposed between cathode 202 and anode 210, and is in contact with separator 208. To create the battery cell, cathode 202, separator 208, and anode 210 may be stacked in a planar configuration, or stacked and then wrapped into a wound configuration. Electrolyte formulation 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil.

In various aspects, the cathode active material can be a layered having the general formula LiₓMO₂, a spinel with the general formula LiₓM₂O₄, or an olivine with the general formula LiₓMPO₄, wherein M is one or more transition metals and 0.90≤x≤1.10.

In some variations, the cathode active material can be an oxide having the general formula LiₓMO₂. Non-limiting examples of such cathode active materials include LiCoO₂ (LCO), Li(NiₓCo_{y}Mn_{z})O₂ (NCM), and LiNi_{0.95}Al_{0.05}O₂ (NCA). Such materials can be, for example, Ser. No. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

In some variations, the cathode active material can be a spinel having the general formula LiₓM₂O₄. Non-limiting examples of such cathode active materials include LiMn₂O₄ (LMO) and LiMn_{1.5}Ni_{0.5}O₄ (LMNO).

In some variations, the cathode active material can be an olivine having the general formula LiₓMPO₄. Non-limiting examples of such cathode active materials include LiFePO₄ and LiMn_{0.8}Fe_{0.2}PO₄ (LMFP).

The structural stability of different classes of cathode active materials increases in the order of layered oxides <spinels <olivines. In some variations of olivine cathode active material, the cathode active material can be lithium iron phosphate (LFP). Li ion battery cells that contain LFP cathodes release less heat than cells containing other types of cathode materials.

In various non-limiting examples, the anode active material can be carbon-based, such as graphite. In additional non-limiting examples, the anode active material can include silicon, silicon oxide, lithium metal, and various alloys. In additional variations, the anode active material can include one or more of graphite, hard carbon, silicon, silicon oxide, silicon-carbon, and composite materials.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte formulation that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte formulation can act a conductive pathway for the movement of cations passing from the negative to the positive electrodes during discharge. The electrolyte formulation can include an electrolyte salt, electrolyte solvent, and one or more electrolyte additives. EC is one of the electrolyte solvents often included in electrolyte formulations.

Thermal runaway in a battery pack can manifest as release of an uncontrolled amounts of heat and flammable gas, for example under abuse conditions. Thermal runaway can occur due to an electrical short between the cathode and anode. Under such conditions, the electrical short increases the battery cell temperature. At higher temperatures, such as those above 100° C., battery cell components can react with each other and decompose to release additional heat. Release of heat can result in decomposition of cathode, decomposition of anode, decomposition of electrolyte formulation components, reaction between cathode and electrolyte formulation components, reaction between anode and electrolyte formulation components, reaction between anode and cathode, and combinations thereof.

EC is able to form an SEI (i.e., passivation layer) at the anode. However, degradation of EC is a highly exothermic reaction can result in a chain reaction of EC. That chain reaction can in turn cause overheating of the battery cell and thermal runaway of a battery pack. By reducing the amount of EC in an electrolyte formulation, or by forming an SEI from an SEI-forming lithium salt such as LiDFOB at the anode before the EC can react, the negative exothermic reaction of EC can be reduced.

In various aspects, the SEI-forming lithium salt can be selected from LiDFOB, lithium bis(oxalate) borate (LiBOB), lithium tetrafluoro oxalato phosphate (LiTFOP), lithium difluoro bis(oxalato) phosphate (LiDFBOP) and lithium difluorophosphate (LiDFP). In some instances, the salt is LiDFOB. In some instances, the salt is LiBOB. In some instances, the salt is LiTFOP. In some instances, the salt is LiDFBOP. In some instances, the salt is LiDFP.

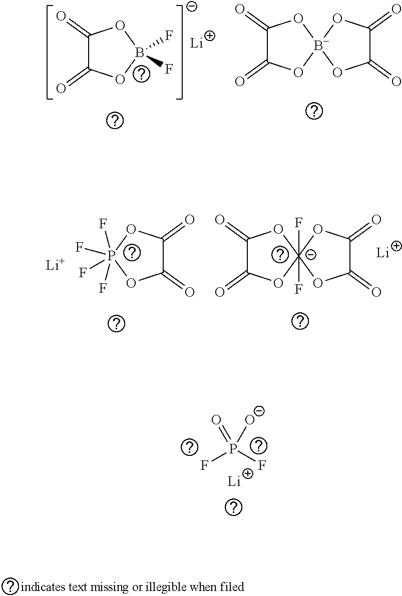

The SEI-forming lithium salts can suppress thermal runaway in lithium ion batteries. In various aspects, the SEI-forming lithium salts that suppress the thermal runaway have either oxygen-boron (O—B) or oxygen-phosphorous (O—P) bonds.

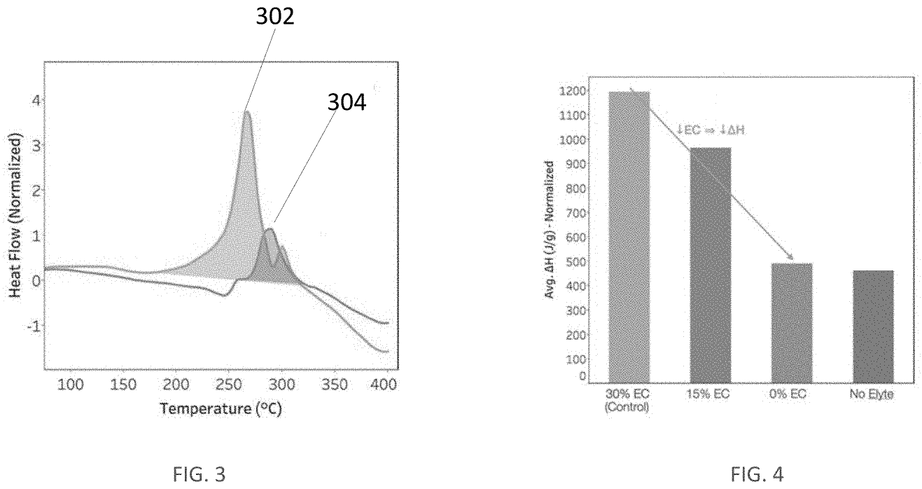

FIG. 3 depicts a DSC curve depicting the heat released from fully charged Li ion battery cells. Peak 302 corresponds to heat flow of 1195 J/g of lithiated graphite anode, and peak 304 corresponds to heat flow of 361 J/g at the lithium iron phosphate (LFP) cathode. The DSC thus shows a larger exothermic peak for the reaction between the charged anode and the electrolyte compared to a charged LiFePO₄ cathode and electrolyte. Higher heat release resulted from the anode and electrolyte reaction compared to the heat released from the reaction between a charged cathode and electrolyte.

FIG. 4 depicts a bar graph of the average normalized heat capacity for three battery cells with electrolyte formulations 1M LiPF₆, 2 wt % vinyl carbonate (VC), and 30 wt %, 15 wt %, and 0 wt % EC, respectively (with the remainder being EMC). For fully charged battery cells with electrolyte formulations containing 30 wt % EC, the heat capacity was nearly 1200 J/g. The heat flow fell to less than 1000 J/g for fully charged battery cells with electrolyte formulations containing 15 wt % EC, and less than 500 J/g fully charged battery cells with electrolyte formulations containing no EC. The heat capacity in the absence of EC was roughly equivalent to the heat capacity than when no electrolyte formulation was present.

Accelerated rate calorimetry (ARC) studies on lithium ion battery cells containing LFP cathodes and graphite-containing anodes confirmed that a reduction in the EC-containing electrolyte formulations reduced both heating rates and total heat release. As shown in Table 1, the total heat released fell substantially as the amount of EC was reduced. Further, the heat rate fell even more precipitously, from 1283° C./rain for electrolyte formulations having 30:70::EC:EMC, to 380° C./min for electrolyte formulations having 15:85::EC:EMC, to 125° C./min for electrolyte formulations having no EC.

TABLE 1

| | Total Heat Release | Heating Rate |
|---|---|---|
| Electrolyte Formulation | (kJ) | (° C./min) |
| 1M LiPF₆, EC:EMC (30:70), 2% | 1732 | 1283 |
| VC | | |
| 1M LiPF₆, EC:EMC (15:70), 2% | 1425 | 389 |
| VC | | |
| 1M LiPF₆, EMC, 2% VC | 1288 | 125 |

In some variations, the amount of EC is equal to or less than 30 wt %. In some variations, the amount of EC is less than 25 wt %. In some variations, the amount of EC is less than 20 wt %. In some variations, the amount of EC is less than 15 wt %. In some variations, the amount of EC is less than 10 wt %. In some variations, the amount of EC is less than 5 wt %. In some variations, the amount of EC is less than 10 wt %. In some variations, the amount of EC is less than 1 wt %. In some variations, the amount of EC is at least 0.01 wt %. In some variations, the amount of EC is at least 1 wt %. In some variations, the amount of EC is at least 5 wt %. In some variations, the amount of EC is at least 10 wt %. In some variations, the amount of EC is at least 15 wt %. In some variations, the amount of EC is at least 20 wt %. In some variations, the amount of EC is at least 25 wt %.

In further variations, the reaction between EC and the charged anode can also be suppressed by forming an SEI on charged anode before EC can react with the anode. For example, an SEI formed from an SEI-forming lithium salt such as LiDFOB can suppress the reaction and reduce the total heat release due to the exothermic degradation of EC at the anode. The SEI thereby reduces, prevents, or slows the highly exothermic EC reaction at the anode surface.

In some variations, the SEI-forming lithium salt can be at least 0.01M. In some variations, the SEI-forming lithium salt can be at least 0.05M. In some variations, the SEI-forming lithium salt can be at least 0.01M. In some variations, the SEI-forming lithium salt can be at least 0.02M. In some variations, the SEI-forming lithium salt can be at least 0.01M. In some variations, the SEI-forming lithium salt can be at least 0.03M. In some variations, the SEI-forming lithium salt can be at least 0.05M. In some variations, the SEI-forming lithium salt can be at least 0.07M. In some variations, the SEI-forming lithium salt can be at least 0.10M. In some variations, the SEI-forming lithium salt can be at least 0.20M. In some variations, the SEI-forming lithium salt can be at least 0.30M. In some variations, the SEI-forming lithium salt can be at least 0.40M. In some variations, the SEI-forming lithium salt can be at least 0.50M. In some variations, the SEI-forming lithium salt can be at least 0.60M. In some variations, the SEI-forming lithium salt can be at least 0.70M.

In some variations, the SEI-forming lithium salt is less than or equal to 0.8M. In some variations, the SEI-forming lithium salt is less than or equal to 0.7M. In some variations, the SEI-forming lithium salt is less than or equal to 0.6M. In some variations, the SEI-forming lithium salt is less than or equal to 0.5M. In some variations, the SEI-forming lithium salt is less than or equal to 0.4M. In some variations, the SEI-forming lithium salt is less than or equal to 0.3M. In some variations, the SEI-forming lithium salt is less than or equal to 02M. In some variations, the SEI-forming lithium salt is less than or equal to 0.10M. In some variations, the SEI-forming lithium salt is less than or equal to 0.08M. In some variations, the SEI-forming lithium salt is less than or equal to 0.06M. In some variations, the SEI-forming lithium salt is less than or equal to 0.06M. In some variations, the SEI-forming lithium salt is less than or equal to 0.04M. In some variations, the SEI-forming lithium salt is less than or equal to 0.02M.

In some variations, the LiDFOB can be at least 0.0 M. In some variations, the LiDFOB can be at least 0.05M. In some variations, the LiDFOB can be at least 0.0 M. In some variations, the LiDFOB can be at least 0.02M. In some variations, the LiDFOB can be at least 0.01M. In some variations, the LiDFOB can be at least 0.03M. In some variations, the LiDFOB can be at least 0.05M. In some variations, the LiDFOB can be at least 0.07M. In some variations, the LiDFOB can be at least 0.10M. In some variations, the LiDFOB can be at least 0.20M. In some variations, the LiDFOB can be at least 0.30M. In some variations, the LiDFOB can be at least 0.40M. In some variations, the LiDFOB can be at least 0.50M. In some variations, the LiDFOB can be at least 0.60M. In some variations, the LiDFOB can be at least 0.70M.

In some variations, the LiDFOB is less than or equal to 0.8M. In some variations, the LiDFOB is less than or equal to 0.7M. In some variations, the LiDFOB is less than or equal to 0.6M. In some variations, the LiDFOB is less than or equal to 0.5M. In some variations, the LiDFOB is less than or equal to 0.4M. In some variations, the LiDFOB is less than or equal to 0.3M. In some variations, the LiDFOB is less than or equal to 02M. In some variations, the LiDFOB is less than or equal to 0.10M. In some variations, the LiDFOB is less than or equal to 0.08M. In some variations, the LiDFOB is less than or equal to 0.06M. In some variations, the LiDFOB is less than or equal to 0.06M. In some variations, the LiDFOB is less than or equal to 0.04M. In some variations, the LiDFOB is less than or equal to 0.02M.

In some variations, other materials can be present in the lithium salt SEI. Likewise, EC SEI refers to an SEI formed from EC degradation products and/or unreacted EC. In some variations, other materials can be present in the EC SEI.

LiDFOB SEI refers to an SEI formed from LiDFOB degradation products and/or unreacted LiDFOB. In some variations, other materials can be present in the LiDFOB SEI. LiBOB SEI refers to an SEI formed from LiBOB degradation products and/or unreacted LiBOB. In some variations, other materials can be present in the LiBOB SEI. LiTFOP SEI refers to an SEI formed from LiTFOP degradation products and/or unreacted LiTFOP. In some variations, other materials can be present in the LiTFOP SEI. LiDFBOP SEI refers to an SEI formed from LiDFBOP degradation products and/or unreacted LiDFBOP. In some variations, other materials can be present in the LiDFBOP SEI. LiDFP SEI refers to an SEI formed from LiDFP degradation products and/or unreacted LiDFP. In some variations, other materials can be present in the LiDFP SEI. Likewise, EC SEI refers to an SEI formed from EC degradation products and/or unreacted EC. In some variations, other materials can be present in the EC SEI.

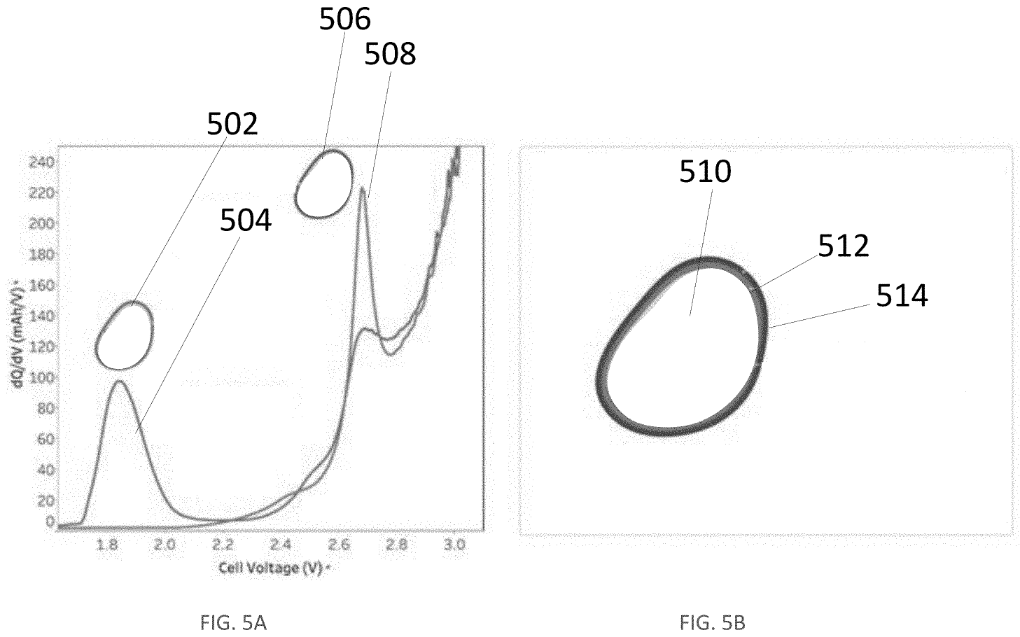

FIG. 5A depicts the dQ/dV as a function of cell voltage for the formation of SEI on the graphite anode active material for different electrolyte formulations. Peak 504 at 1.85 V corresponds to formation of a LiDFOB SEI on the graphite anode active material in a battery having the electrolyte formulation 0.8M LiPF₆, 0.2M LiDFOB, a combination of EMC and dimethyl carbonate (DMC) in a ratio of EMC:DMC::4:6, and 2 wt % VC. Peak 508 at 2.75 V corresponds to formation of an EC SEI on the graphite anode active material in a battery having the electrolyte formulation 1.0 M LiPF₆, EC:EMC::3:7, and 2 wt % VC. The LiDFOB SEI LiDFOB forms at a lower voltage than EC. An EC SEI can form on the outer surface of the LiDFOB.

With further reference to FIG. 5A, LiDFOB SEI 502 forms on the graphite-containing anode surface at 1.85V. The EC SEI 506 forms on the graphite anode active material surface at 2.75 V. By contrast, with reference to FIG. 5B, the LiDFOB SEI 512 forms on the surface of the anode active material 510, and the EC SEI 514 forms on the surface of the LiDFOB SEI 512. By forming an LiDFOB SEI 512 first, a stable SEI is formed before EC can react with the charged anode active material.

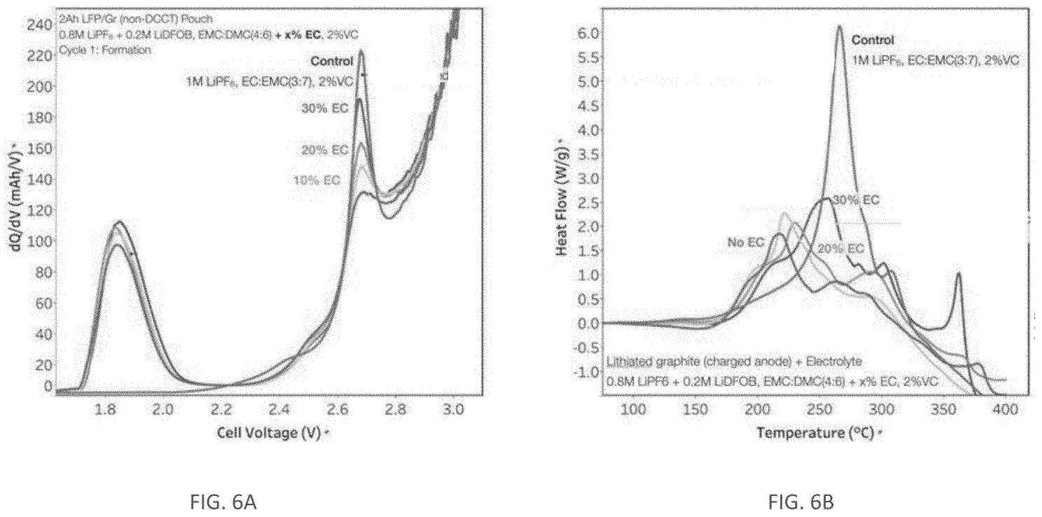

FIG. 6A depicts the dQ/dV as a function of cell voltage for battery cells having the electrolyte formulation of 0.8M LiPF₆, 0.2M LiDFOB, EMC:DMC::4:6, 2 wt % VC, and different quantities of EC. The consistent formation of a LiDFOB SEI on anodes in battery cells containing electrolyte formulations with different amount of EC confirms that a LiDFOB SEI forms at lower voltage, and before, EC SEI.

Similarly, FIG. 6B depicts a DSC for the battery cells in FIG. 6A that have different quantities of EC. The DSC study shows that despite high EC concentration, the overall heat release due to reaction between EC and the charged graphite-containing anode can be reduced and/or slowed with the addition of LiDFOB.

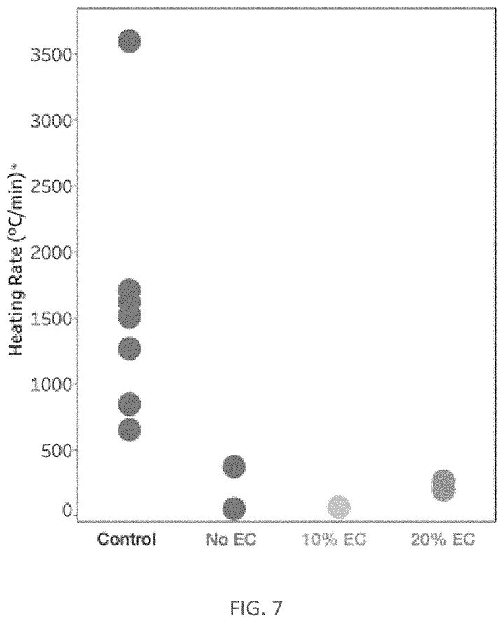

FIG. 7 depicts the heating rate of battery cells with electrolyte formulations having 0.8M LiPF₆, 0.2M LiDFOB, EMC:DMC::4:6, 2 wt % VC, and different quantities of EC. The control has no LiDFOB, while the formulations labeled No EC, 10% EC, and 20% EC all include LiDFOB. In the absence of LiDFOB, the resulting heating creates a chain reaction as the exothermic degradation reaction of EC, which results in thermal runaway. In the presence of LiDFOB, the formation of an LiDFOB SEI does not result in a chain reaction for any quantity of EC (10%, 20%, and 30%).

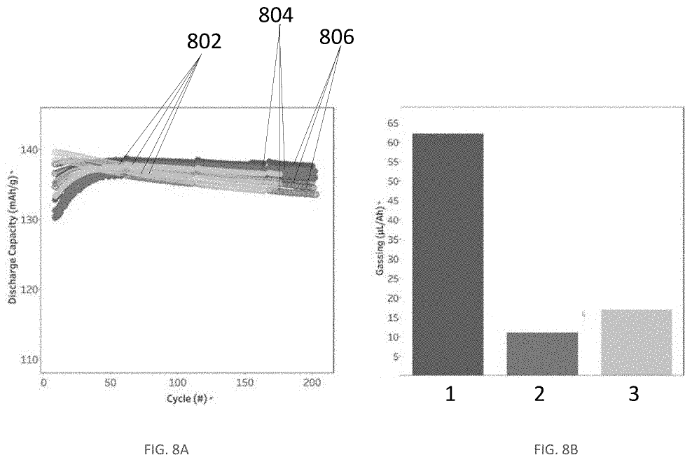

FIG. 8A depicts the discharge capacity as a function of cycle number for battery cells containing three separate electrolyte formulations. Electrolyte Formulation 802 included 0.8M LiPF₆, 0.2M LiDFOB, EC:EMC:DMC::10:36:54, and 2 wt % VC. Electrolyte Formulation 804 included 0.8M LiPF₆, 0.2M LiDFOB, EMC:DMC::40:60, and 2 wt % VC. Electrolyte Formulation 806 included 1M LiPF₆, EC:EMC:DEC:DMC::34.1:38.7:13.1:14.1, 3.1 wt % VC, and 1% MMDS. Discharge capacity remained roughly consistent for each electrolyte formulation over 200 battery cycles. The addition of LiDFOB to EC does not show a significant difference in performance in different formulations.

FIG. 8B depicts a bar graph for gas creation of battery cells having three different electrolyte formulations. Electrolyte Formulation 1 included 1M LiPF₆, EC:EMC:DEC:DMC::34.1:38.7:13.1:14.1, 3.1 wt % VC, and 1% MMDS. Electrolyte Formulation 2 included 0.8M LiPF₆, 0.2M LiDFOB, EMC:DMC::40:60, and 2 wt % VC.

Electrolyte Formulation 3 included 0.8M LiPF₆, 0.2M LiDFOB, EC:EMC:DMC::10:36:54, and 2 wt % VC. The battery cells were fully charged and held at high temperature (85° C.) for seven days. In the absence of LiDFOB, gas formation was substantially higher than in battery cells having electrolyte formulations that contained LiDFOB. The shelf life of charged battery cells having electrolyte formulations containing LiDFOB in addition to EC can be substantially higher.

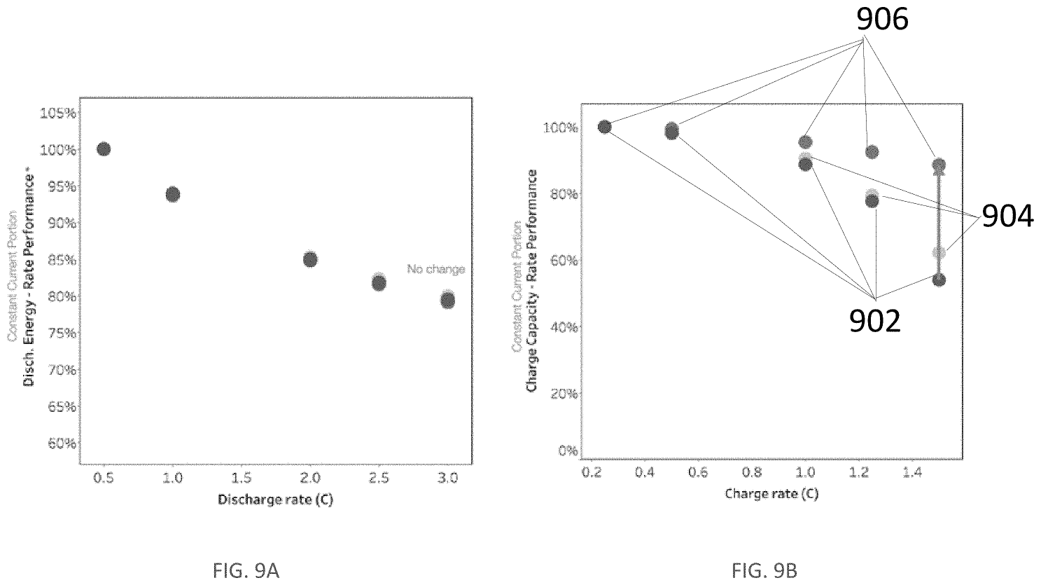

FIG. 9A depicts the discharge energy rate performance as a function of discharge rate for three different electrolyte formulations. Battery cells having different electrolyte formulations showed no change. However, FIG. 9B depicts the charge capacity rate performance as a function of charge rate. Electrolyte Formulation 902 included 1M LiPF₆, EC:EMC:DEC:DMC::34.1:38.7:13.1:14.1, 3.1 wt % VC, and 1% MMDS. Electrolyte Formulation 904 included 0.8M LiPF₆, 0.2M LiDFOB, EC:EMC:DMC::10:36:54, and 2 wt % VC. Electrolyte Formulation 906 included 0.8M LiPF₆, 0.2M LiDFOB, EMC:DMC::40:60, and 2 wt % VC. Battery Cells containing Electrolyte Formulation 902, lacking LiDFOB and EC, had decreased charge capacity as a function of charge rate. Battery Cells containing Electrolyte Formulation 904 including both EC and LiDFOB had a slightly improved charge capacity as a function of charge rate. Battery cells containing Electrolyte Formulation 906 with LiDFOB but without EC had the highest charge capacity as a function of charge rate.

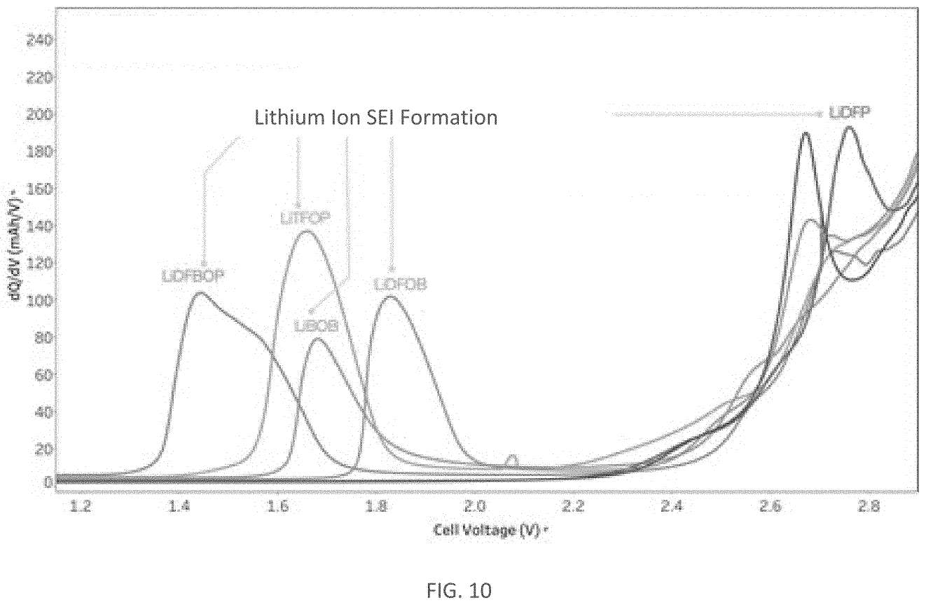

FIG. 10 depicts the dQ/dV as a function of cell voltage for different lithium salt SEI on the graphite anode for different electrolyte formulations as compared to a control. The SEI-forming lithium salt containing formulations were:

0.8M LiPF₆+0.2M LiDFOB,EC:EMC:DMC(10:36:54),2% VC i.

0.8M LiPF₆+0.2M LiBOB,EC:EMC:DMC(10:36:54),2% VC ii.

0.8M LiPF₆+0.2M LiTFOP,EC:EMC:DMC(10:36:54),2% VC iii.

0.8M LiPF₆+0.2M LiDFBOP,EC:EMC:DMC(10:36:54),2% VC iv.

0.8M LiPF₆+0.2M LiDFP,EC:EMC:DMC(10:36:54),2% VC v.

The control formulation was 1.0 M LiPF₆+EC:EMC (3:7), 2% VC. Results from LFP/graphite pouch cell testing show that addition of LiDFOB, LiBOB, LiTFOP, LiDFBOP and LiDFP to the electrolyte formulation results in formation of different type of lithium salt SEI.

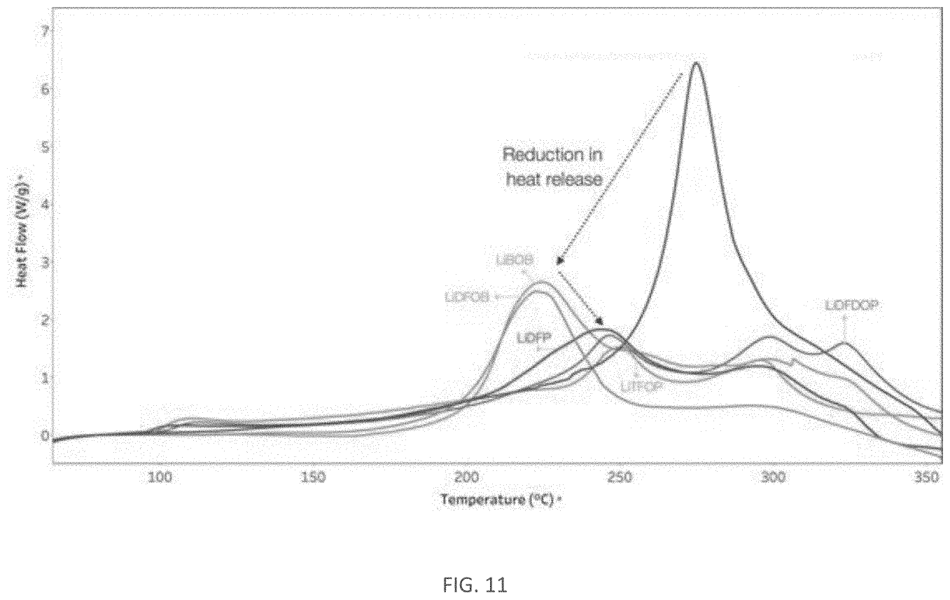

FIG. 11 depicts differential scanning calorimeter (DSC) tests showing that electrolytes containing the SEI-forming lithium salts LiDFOB, LiDFBOP, LiBOB, LiTFOP and LiDFP as compared to a control. The SEI-forming lithium salt containing formulations were the same as in FIG. 10. The control was 1M LiPF₆, EC:EMC:DEC:DMC(34.1:38.7:13.1:14.1 w), 3.1% VC+1% MMDS. Each of the electrolyte formulations containing the lithium salts releases less heat compared to control electrolyte when the electrolytes react with lithiated graphite. This reduction in released heat indicates the suppression of reaction between lithiated anode and the electrolyte. In various instances, different types of SEI formed with the test electrolyte are more stable compared to the SEI formed with ethylene carbonate in control electrolyte. As such, the reaction between the lithiated anode surface and electrolyte is slowed.

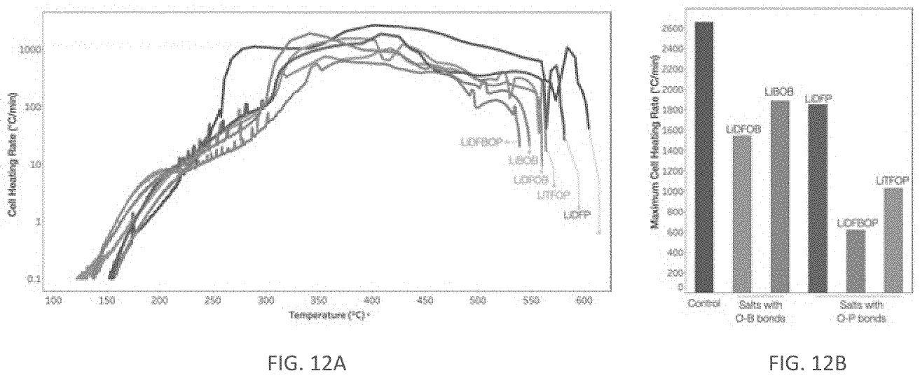

FIG. 12A depicts an accelerated rate calorimetry (ARC) testing of the LFP/graphite pouch cells. The SEI-forming lithium salt containing formulations and control formulation were the same as in FIG. 11. Electrolytes that include the SEI-forming lithium salts LiDFOB, LiDFBOP, LiBOB, LiTFOP, and LiDFP each reduce the heating rate and the cell temperature during thermal runaway as compared to a control lacking the SEI-forming lithium salts.

FIG. 12B depicts the maximum cell heating rate for different SEI-forming lithium salts having O—B and O—P chemical structures, as compared to a control. Both SEI-forming lithium salts that include an O—B bond and an O—P bond have lower maximum cell heating rate than a control lacking an SEI-forming lithium salt. Those SEI-forming lithium salts that include an O—B bond had a maximum cell heating rate between 1550° C./min and 2000° C./min. Those SEI-forming lithium salts that include an O—B bond have a higher maximum cell heating rate.

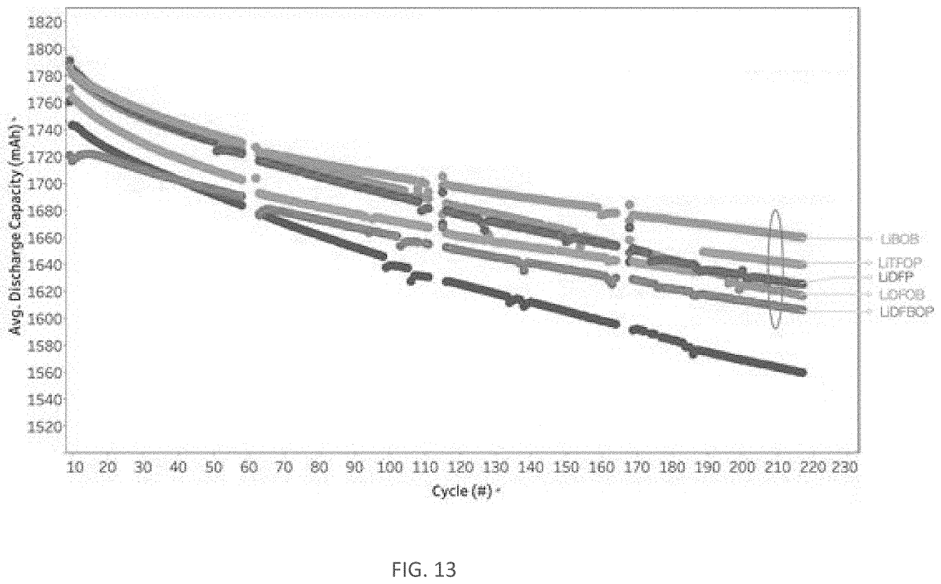

FIG. 13 depicts the cycle aging of LFP/graphite pouch cells with electrolytes containing the SEI-forming lithium salts as compared to a control lacking an SEI-forming lithium salt at 50° C. The cells containing SEI-forming lithium salts electrolytes showed better capacity retention after 200 cycles indicating that the identified salts can also improve the electrochemical performance of the lithium ion battery cells.

The electrolyte formulation can include additional components, including electrolyte salts, electrolyte solvents, and electrolyte additives.

The electrolyte formulation can have one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiBF₂(C₂O₄), and LiC(SO₂CF₃)₃. Other salts are possible, including combinations of salts.

In some variations, the salt is at least 0.1 M in the total electrolyte formulation. In some variations, the salt is at least 0.2 M in the total electrolyte formulation. In some variations, the salt is at least 0.3 M in the total electrolyte formulation. In some variations, the salt is at least 0.4 M in the total electrolyte formulation. In some variations, the salt is at least 0.5 M in the total electrolyte formulation. In some variations, the salt is at least 0.6 M in the total electrolyte formulation. In some variations, the salt is at least 0.7 M in the total electrolyte formulation. In some variations, the salt is at least 0.8 M in the total electrolyte formulation. In some variations, the salt is at least 0.9 M in the total electrolyte formulation. In some variations, the salt is at least 1.0 M in the total electrolyte formulation. In some variations, the salt is at least 1.3 M in the total electrolyte formulation. In some variations, the salt is at least 1.6 M in the total electrolyte formulation. In some variations, the salt is at least 1.9 M in the total electrolyte formulation.

In some variations, the salt is less than or equal to 2.0 M in the electrolyte formulation. In some variations, the salt is less than or equal to 1.9 M in the electrolyte formulation. In some variations, the salt is less than or equal to 1.6 M in the electrolyte formulation. In some variations, the salt is less than or equal to 1.3 M in the electrolyte formulation. In some variations, the salt is less than or equal to 1.1 M in the electrolyte formulation. In some variations, the salt is less than or equal to 1.0 M in the electrolyte formulation. In some variations, the salt is less than or equal to 0.9 M in the electrolyte formulation. In some variations, the salt is less than or equal to 0.8 M in the electrolyte formulation. In some variations, the salt is less than or equal to 0.7 M in the electrolyte formulation. In some variations, the salt is less than or equal to 0.6 M in the electrolyte formulation. In some variations, the salt is less than or equal to 0.5 M in the electrolyte formulation. In some variations, the salt is less than or equal to 0.4 M in the electrolyte formulation. In some variations, the salt is less than or equal to 0.3 M in the electrolyte formulation. In some variations, the salt is less than or equal to 0.2 M in the electrolyte formulation.

The electrolyte formulation can include electrolyte solvents in addition to EC. The electrolyte solvent may be any type of electrolyte solvent suitable for battery cells. Electrolyte solvents can contain a mixture of organic solvents such as, but not limited to, carbonates, esters, ethers, nitriles, ionic liquids. Examples of solvent blends include EC, as well as linear carbonates such as dimethyl carbonate (DMC), diethyl carbonate (DEC) and ethyl methyl carbonate (EMC). Non-limiting examples of the electrolyte solvents include propylene carbonate (PC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), or combinations thereof.

In some variations, a particular solvent can be at least 5 wt % of total solvent. In some variations, a particular solvent can be at least 10 wt % of total solvent. In some variations, a particular solvent can be at least 15 wt % of total solvent. In some variations, a particular solvent can be at least 20 wt % of total solvent. In some variations, a particular solvent can be at least 25 wt % of total solvent. In some variations, a particular solvent can be at least 30 wt % of total solvent. In some variations, a particular solvent can be at least 35 wt % of total solvent. In some variations, a particular solvent can be at least 40 wt % of total solvent. In some variations, a particular solvent can be at least 45 wt % of total solvent. In some variations, a particular solvent can be at least 50 wt % of total solvent. In some variations, a particular solvent can be at least 55 wt % of total solvent. In some variations, a particular solvent can be at least 60 wt % of total solvent. In some variations, a particular solvent can be at least 65 wt % of total solvent. In some variations, a particular solvent can be at least 70 wt % of total solvent. In some variations, a particular solvent can be at least 75 wt % of total solvent. In some variations, a particular solvent can be at least 80 wt % of total solvent. In some variations, a particular solvent can be at least 85 wt % of total solvent. In some variations, a particular solvent can be at least 90 wt % of total solvent.

In some variations, a particular solvent is equal to or less than 95 wt % of the total solvent. In some variations, a particular solvent is equal to or less than 90 wt % of the total solvent. In some variations, a particular solvent is equal to or less than 85 wt % of the total solvent. In some variations, a particular solvent is equal to or less than 80 wt % of the total solvent. In some variations, a particular solvent is equal to or less than 75 wt % of the total solvent. In some variations, a particular solvent is equal to or less than 70 wt % of the total solvent. In some variations, a particular solvent is equal to or less than 65 wt % of the total solvent. In some variations, a particular solvent is equal to or less than 60 wt % of the total solvent. In some variations, a particular solvent is equal to or less than 55 wt % of the total solvent. In some variations, a particular solvent is equal to or less than 50 wt % of the total solvent. In some variations, a particular solvent is equal to or less than 45 wt % of the total solvent. In some variations, a particular solvent is equal to or less than 40 wt % of the total solvent. In some variations, a particular solvent is equal to or less than 35 wt % of the total solvent. In some variations, a particular solvent is equal to or less than 30 wt % of the total solvent. In some variations, a particular solvent is equal to or less than 25 wt % of the total solvent. In some variations, a particular solvent is equal to or less than 20 wt % of the total solvent. In some variations, a particular solvent is equal to or less than 15 wt % of the total solvent. In some variations, a particular solvent is equal to or less than 10 wt % of the total solvent.

In some variations, the electrolyte solvent includes EC in a ratio to other solvents present. For example, EC can be present in a particular ratio to EMC. In some variations, the ratio of EC to other solvents can be less than 30:70. In some variations, the ratio of EC to other solvents can be less than 25:75. In some variations, the ratio of EC to other solvents can be less than 20:80. In some variations, the ratio of EC to other solvents can be less than 15:85. In some variations, the ratio of EC to other solvents can be less than 10:90. In some variations, the ratio of EC to other solvents can be less than 5:95.

In some variations, the electrolyte formulation can include one or more additional electrolyte additives. In various aspects, the electrolyte additives can include pro-1-ene-1,3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and/or 1,3,6-hexanetricarbonitrile (HTCN), tris(trimethyl silyl) phosphite (TMSP), in any combination.

In some variations, the amount of PES is at least 0.5 wt % of the total electrolyte formulation. In some variations, the amount of PES is at least 0.6 wt % of the total electrolyte formulation. In some variations, the amount of PES is at least 0.9 wt % of the total electrolyte formulation. In some variations, the amount of PES is at least 1.3 wt % of the total electrolyte formulation. In some variations, the amount of PES is at least 1.6 wt % of the total electrolyte formulation. In some variations, the amount of PES is at least 1.9 wt % of the total electrolyte formulation. In some variations, the amount of PES is at least 2.2 wt % of the total electrolyte formulation. In some variations, the amount of PES is at least 2.5 wt % of the total electrolyte formulation. In some variations, the amount of PES is at least 2.8 wt % of the total electrolyte formulation. In some variations, the amount of PES is at least 3.1 wt % of the total electrolyte formulation.

In some variations, the amount of PES is less than or equal to 3.5 wt % of the total electrolyte formulation. In some variations, the amount of PES is less than or equal to 3.1 wt % of the total electrolyte formulation. In some variations, the amount of PES is less than or equal to 2.8 wt % of the total electrolyte formulation. In some variations, the amount of PES is less than or equal to 2.5 wt % of the total electrolyte formulation. In some variations, the amount of PES is less than or equal to 2.2 wt % of the total electrolyte formulation. In some variations, the amount of PES is less than or equal to 1.9 wt % of the total electrolyte formulation. In some variations, the amount of PES is less than or equal to 1.6 wt % of the total electrolyte formulation. In some variations, the amount of PES is less than or equal to 1.3 wt % of the total electrolyte formulation. In some variations, the amount of PES is less than or equal to 1.1 wt % of the total electrolyte formulation. In some variations, the amount of PES is less than or equal to 0.9 wt % of the total electrolyte formulation. In some variations, the amount of PES is less than or equal to 0.6 wt % of the total electrolyte formulation.

In some variations, the amount of MMDS is at least 0.1 wt % of the total electrolyte formulation. In some variations, the amount of MMDS is at least 0.2 wt % of the total electrolyte formulation. In some variations, the amount of MMDS is at least 0.3 wt % of the total electrolyte formulation. In some variations, the amount of MMDS is at least 0.4 wt % of the total electrolyte formulation. In some variations, the amount of MMDS is at least 0.5 wt % of the total electrolyte formulation. In some variations, the amount of MMDS is at least 0.6 wt % of the total electrolyte formulation. In some variations, the amount of MMDS is at least 0.7 wt % of the total electrolyte formulation. In some variations, the amount of MMDS is at least 0.8 wt % of the total electrolyte formulation. In some variations, the amount of MMDS is at least 0.9 wt % of the total electrolyte formulation. In some variations, the amount of MMDS is at least 1.0 wt % of the total electrolyte formulation. In some variations, the amount of MMDS is at least 1.1 wt % of the total electrolyte formulation. In some variations, the amount of MMDS is at least 1.2 wt % of the total electrolyte formulation. In some variations, the amount of MMDS is at least 1.3 wt % of the total electrolyte formulation. In some variations, the amount of MMDS is at least 1.4 wt % of the total electrolyte formulation.

In some variations, the amount of MMDS is less than or equal to 1.5 wt % of the total electrolyte formulation. In some variations, the amount of MMDS is less than or equal to 1.4 wt % of the total electrolyte formulation. In some variations, the amount of MMDS is less than or equal to 1.3 wt % of the total electrolyte formulation. In some variations, the amount of MMDS is less than or equal to 1.2 wt % of the total electrolyte formulation. In some variations, the amount of MMDS is less than or equal to 1.1 wt % of the total electrolyte formulation. In some variations, the amount of MMDS is less than or equal to 1.0 wt % of the total electrolyte formulation. In some variations, the amount of MMDS is less than or equal to 0.9 wt % of the total electrolyte formulation. In some variations, the amount of MMDS is less than or equal to 0.8 wt % of the total electrolyte formulation. In some variations, the amount of MMDS is less than or equal to 0.7 wt % of the total electrolyte formulation. In some variations, the amount of MMDS is less than or equal to 0.6 wt % of the total electrolyte formulation. In some variations, the amount of MMDS is less than or equal to 0.5 wt % of the total electrolyte formulation. In some variations, the amount of MMDS is less than or equal to 0.4 wt % of the total electrolyte formulation. In some variations, the amount of MMDS is less than or equal to 0.3 wt % of the total electrolyte formulation. In some variations, the amount of MMDS is less than or equal to 0.2 wt % of the total electrolyte formulation.

In some variations, the amount of VEC is at least 0.05 wt % of the total electrolyte formulation. In some variations, the amount of VEC is at least 0.1 wt % of the total electrolyte formulation. In some variations, the amount of VEC is at least 0.2 wt % of the total electrolyte formulation. In some variations, the amount of VEC is at least 0.3 wt % of the total electrolyte formulation. In some variations, the amount of VEC is at least 0.4 wt % of the total electrolyte formulation. In some variations, the amount of VEC is at least 0.5 wt % of the total electrolyte formulation. In some variations, the amount of VEC is at least 0.6 wt % of the total electrolyte formulation. In some variations, the amount of VEC is at least 0.7 wt % of the total electrolyte formulation. In some variations, the amount of VEC is at least 0.8 wt % of the total electrolyte formulation. In some variations, the amount of VEC is at least 0.9 wt % of the total electrolyte formulation.

In some variations, the amount of VEC is less than or equal to 0.9 wt % of the total electrolyte formulation. In some variations, the amount of VEC is less than or equal to 0.8 wt % of the total electrolyte formulation. In some variations, the amount of VEC is less than or equal to 0.7 wt % of the total electrolyte formulation. In some variations, the amount of VEC is less than or equal to 0.6 wt % of the total electrolyte formulation. In some variations, the amount of VEC is less than or equal to 0.5 wt % of the total electrolyte formulation. In some variations, the amount of VEC is less than or equal to 0.4 wt % of the total electrolyte formulation. In some variations, the amount of VEC is less than or equal to 0.3 wt % of the total electrolyte formulation. In some variations, the amount of VEC is less than or equal to 0.2 wt % of the total electrolyte formulation. In some variations, the amount of VEC is less than or equal to 0.1 wt % of the total electrolyte formulation.

In some variations, the amount of FEC is at least 2 wt % of the total electrolyte formulation. In some variations, the amount of FEC is at least 4 wt % of the total electrolyte formulation. In some variations, the amount of FEC is at least 6 wt % of the total electrolyte formulation. In some variations, the amount of FEC is at least 8 wt % of the total electrolyte formulation. In some variations, the amount of FEC is less than or equal to 10 wt % of the total electrolyte formulation. In some variations, the amount of FEC is less than or equal to 8 wt % of the total electrolyte formulation. In some variations, the amount of FEC is less than or equal to 6 wt % of the total electrolyte formulation. In some variations, the amount of FEC is less than or equal to 4 wt % of the total electrolyte formulation.

In some variations, the amount of PS is at least 0.5 wt % of the total electrolyte formulation. In some variations, the amount of PS is at least 1.0 wt % of the total electrolyte formulation. In some variations, the amount of PS is at least 1.5 wt % of the total electrolyte formulation. In some variations, the amount of PS is at least 2.0 wt % of the total electrolyte formulation. In some variations, the amount of PS is at least 2.5 wt % of the total electrolyte formulation. In some variations, the amount of PS is at least 3.0 wt % of the total electrolyte formulation. In some variations, the amount of PS is at least 3.5 wt % of the total electrolyte formulation. In some variations, the amount of PS is at least 4.0 wt % of the total electrolyte formulation. In some variations, the amount of PS is at least 4.5 wt % of the total electrolyte formulation. In some variations, the amount of PS is at least 5.0 wt % of the total electrolyte formulation.

In some variations, the amount of PS is less than or equal to 6.0 wt % of the total electrolyte formulation. In some variations, the amount of PS is less than or equal to 5.5 wt % of the total electrolyte formulation. In some variations, the amount of PS is less than or equal to 5.0 wt % of the total electrolyte formulation. In some variations, the amount of PS is less than or equal to 4.5 wt % of the total electrolyte formulation. In some variations, the amount of PS is less than or equal to 4.0 wt % of the total electrolyte formulation. In some variations, the amount of PS is less than or equal to 3.5 wt % of the total electrolyte formulation. In some variations, the amount of PS is less than or equal to 3.0 wt % of the total electrolyte formulation. In some variations, the amount of PS is less than or equal to 2.5 wt % of the total electrolyte formulation. In some variations, the amount of PS is less than or equal to 2.0 wt % of the total electrolyte formulation. In some variations, the amount of PS is less than or equal to 1.5 wt % of the total electrolyte formulation. In some variations, the amount of PS is less than or equal to 1.0 wt % of the total electrolyte formulation.

In some variations, the amount of SN is at least 0.5 wt % of the total electrolyte formulation. In some variations, the amount of SN is at least 1.0 wt % of the total electrolyte formulation. In some variations, the amount of SN is at least 1.5 wt % of the total electrolyte formulation. In some variations, the amount of SN is at least 2.0 wt % of the total electrolyte formulation. In some variations, the amount of SN is at least 2.5 wt % of the total electrolyte formulation. In some variations, the amount of SN is at least 3.0 wt % of the total electrolyte formulation. In some variations, the amount of SN is at least 3.5 wt % of the total electrolyte formulation. In some variations, the amount of SN is at least 4.0 wt % of the total electrolyte formulation. In some variations, the amount of SN is at least 4.5 wt % of the total electrolyte formulation. In some variations, the amount of SN is at least 5.0 wt % of the total electrolyte formulation.

In some variations, the amount of SN is less than or equal to 6.0 wt % of the total electrolyte formulation. In some variations, the amount of SN is less than or equal to 5.5 wt % of the total electrolyte formulation. In some variations, the amount of SN is less than or equal to 5.0 wt % of the total electrolyte formulation. In some variations, the amount of SN is less than or equal to 4.5 wt % of the total electrolyte formulation. In some variations, the amount of SN is less than or equal to 4.0 wt % of the total electrolyte formulation. In some variations, the amount of SN is less than or equal to 3.5 wt % of the total electrolyte formulation. In some variations, the amount of SN is less than or equal to 3.0 wt % of the total electrolyte formulation. In some variations, the amount of SN is less than or equal to 2.5 wt % of the total electrolyte formulation. In some variations, the amount of SN is less than or equal to 2.0 wt % of the total electrolyte formulation. In some variations, the amount of SN is less than or equal to 1.5 wt % of the total electrolyte formulation. In some variations, the amount of SN is less than or equal to 1.0 wt % of the total electrolyte formulation.

In some variations, the amount of HTCN is at least 0.5 wt % of the total electrolyte formulation. In some variations, the amount of HTCN is at least 1.0 wt % of the total electrolyte formulation. In some variations, the amount of HTCN is at least 1.5 wt % of the total electrolyte formulation. In some variations, the amount of HTCN is at least 2.0 wt % of the total electrolyte formulation. In some variations, the amount of HTCN is at least 2.5 wt % of the total electrolyte formulation. In some variations, the amount of HTCN is at least 3.0 wt % of the total electrolyte formulation. In some variations, the amount of HTCN is at least 3.5 wt % of the total electrolyte formulation. In some variations, the amount of HTCN is at least 4.0 wt % of the total electrolyte formulation. In some variations, the amount of HTCN is at least 4.5 wt % of the total electrolyte formulation. In some variations, the amount of HTCN is at least 5.0 wt % of the total electrolyte formulation.

In some variations, the amount of HTCN is less than or equal to 6.0 wt % of the total electrolyte formulation. In some variations, the amount of HTCN is less than or equal to 5.5 wt % of the total electrolyte formulation. In some variations, the amount of HTCN is less than or equal to 5.0 wt % of the total electrolyte formulation. In some variations, the amount of HTCN is less than or equal to 4.5 wt % of the total electrolyte formulation. In some variations, the amount of HTCN is less than or equal to 4.0 wt % of the total electrolyte formulation. In some variations, the amount of HTCN is less than or equal to 3.5 wt % of the total electrolyte formulation. In some variations, the amount of HTCN is less than or equal to 3.0 wt % of the total electrolyte formulation. In some variations, the amount of HTCN is less than or equal to 2.5 wt % of the total electrolyte formulation. In some variations, the amount of HTCN is less than or equal to 2.0 wt % of the total electrolyte formulation. In some variations, the amount of HTCN is less than or equal to 1.5 wt % of the total electrolyte formulation. In some variations, the amount of HTCN is less than or equal to 1.0 wt % of the total electrolyte formulation.

The electrolyte formulations described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode and the anode;
a lithium salt solid electrolyte interface (lithium salt SEI) formed on the anode active material; and
an electrolyte formulation comprising
0.01 wt %-30.0 wt % ethylene carbonate (EC) relative to the total weight of the electrolyte formulation, and
the SEI-forming lithium salt.

2. The battery cell of claim 1, wherein the SEI-forming lithium salt is selected from lithium difluoro(oxalato)borate (LiDFOB), lithium bis(oxalate) borate (LiBOB), lithium tetrafluoro oxalato phosphate (LiTFOP), lithium difluoro bis(oxalato) phosphate (LiDFBOP) and lithium difluorophosphate (LiDFP).

3. (canceled)

4. The battery cell of claim 1, further comprising an EC SEI formed on the lithium salt SEI.

5. (canceled)

6. The battery cell of claim 1, wherein the lithium salt SEI does not comprise degradation products formed from EC.

7. (canceled)

8. The battery cell of claim 1, wherein SEI-forming lithium salt is from 0.01 M-0.8M.

9. (canceled)

10. The battery cell of claim 1, wherein the electrolyte formulation comprises equal to or less than 15 wt % ethylene carbonate (EC).

11. The battery cell of claim 1, wherein the electrolyte formulation comprises ethyl methyl carbonate (EMC).

12. (canceled)

13. (canceled)

14. The battery cell of claim 1, wherein the electrolyte formulation comprises an electrolyte salt selected from LiPF₆, LiN(SO₂F)₂, LiBF₄, LiClO₄, LiSO₃CF₃, LiN(SO₂CF₃)₂, LiBC₄O₈, LiBF₂(C₂O₄), Li[PF₃(C₂CF₅)₃], LiC(SO₂CF₃)₃, and a combination thereof.

15. The battery cell of claim 14, wherein the electrolyte salt is LiPF₆.

16. The battery cell of claim 14, wherein the electrolyte salt has a concentration of 0.6 M to 1.6 M in the electrolyte formulation.

17. The battery cell of claim 1, wherein the electrolyte formulation further comprises a solvent selected from one or more carbonates, one or more esters, one or more ethers, one or more nitriles, one or more ionic liquids, or a combination thereof.

18. The battery cell of any claim 17, wherein the solvent is selected from one or more of propylene carbonate (PC), dimethyl carbonate (DMC), diethyl carbonate (DEC), ethyl propionate (EP), butyl butyrate (BB), methyl acetate (MA), ethyl acetate (EA), propyl propionate (PP), butyl propionate (BP), propyl acetate (PA), and butyl acetate (BA), and a combination thereof.

19. The battery cell of claim 1, wherein the electrolyte formulation comprises one or more additional additives selected from vinylene carbonate (VC), propylene sultone (PS), fluoroethylene carbonate (FEC), succinonitrile (SN), 1,3,6-hexanetricarbonitrile (HTCN), tris(trimethylsilyl) phosphite (TMSP), methylene methanedisulfonate (MMDS), and a combination thereof.

20. The battery cell of claim 19, wherein the additional additive is VC.

21. The battery cell of claim 1, wherein the cathode active material is selected from a lithium containing layered oxide having the formula LiₓMO₂, a spinel having the formula LiₓM₂O₂, and an olivine having the formula LiₓMPO₄,
wherein M is one or more transition metals and 0.90≤x≤1.10.

22. The battery cell of claim 21, wherein the cathode active material is LiMPO₄.

23. The battery cell of claim 22, wherein the LiMPO₄ is selected from LiFePO₄ and LiMn_{0.8}Fe_{0.2}PO₄ (LMFP).

24. The battery cell of claim 21, wherein the cathode active material is LiₓMO₂ selected from LiCoO₂ (LCO), Li(NiₓCo_{y}Mn_{z})O₂ (NCM) LiNi_{0.95}Al_{0.05}O₂ (NCA).

25. The battery cell of claim 21, wherein the cathode active material is LiₓM₂O₄ selected from LiMn₂O₄ (LMO) and LiMn_{1.5}Ni_{0.5}O₄ (LMNO).

26. The battery cell of any claim 1, wherein the anode active material is selected from graphite, hard carbon, silicon, silicon oxide, silicon-carbon, a composite material, and a combination thereof.
